(19) United States
(12) Patent Application Publication
(10) Pub. No.: US 2006/0236504 A1
(43) Pub. Date: Oct. 26, 2006

(54) Hinge

(75) Inventors: Sheng-Nan Lu, Shulin City (TW); Ting-Hsien Wang, Shulin City (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Shin Zu Shing Co., Ltd., Shulin City (TW)

(21) Appl. No.: 11/375,322

(22) Filed: Mar. 14, 2006

(30) Foreign Application Priority Data
Apr. 22, 2005 (TW) 094206309

(51) Int. Cl. E05D 11/08

(52) U.S. Cl. 16/342

(57) ABSTRACT

A hinge has a sleeve and a shaft and is mounted between a cover and a base of an electrical device. The sleeve is hollow, is attached to the base and has an internal diameter. The shaft is attached to the cover, is mounted pivotally in the sleeve and has a hollow torsion rod. The torsion rod has an external diameter, an opening end and multiple slots. The external diameter of the torsion rod is bigger than the internal diameter of the sleeve to provide friction. The slots are formed in the torsion rod without communicating with the opening end to provide uniform friction. Because the torsion rod is hollow to provide spaces for the torsion rod to be deformed, the torsion rod maintains its shape. Therefore the torsion rod provides uniform friction with the sleeve.

### BACKGROUND OF THE INVENTION

1. Field of the Invention

The present invention relates to a hinge, especially to a hinge mounted in an electrical appliance to allow a cover to pivot relative to a base.

2. Description of the Prior Arts

Electrical devices such as notebook computers, cellular phones, etc. comprise a cover, a base and a hinge. The hinge is mounted between the cover and the base to allow the cover to pivot relative to the base. Conventional hinges are available in many types. With reference to FIGS. 6 and 7, one type of conventional hinges comprises a sleeve (50) and a shaft (60). The sleeve (50) has an internal diameter, an opening end (51), a closed end, a limit (52) and a leaf (53). The limit (52) is formed longitudinally on the opening end (51). The leaf (53) is formed on and protrudes longitudinally from the closed end and attaches to a base of an electrical device. The shaft (60) is mounted rotatably in the sleeve (50) and has a head, a torsion rod (61), a keyed leaf (62) and a stop (63). The head has a proximal side, a distal side and an edge. The torsion rod (61) is solid, is formed on and protrudes coaxially from the proximal side of the head, extends into the opening end (51) of the sleeve (50) and has an external diameter, an outer wall, two ends and multiple slots (611). The external diameter of the torsion rod (61) is bigger than the internal diameter of the sleeve (50) to provide friction between the sleeve (50) and the torsion rod (61). The slots (611) are separately formed longitudinally in the outer wall of the torsion rod (61) and extend through two ends of the torsion rod (61). The keyed leaf (62) is formed on and protrudes coaxially from the distal side of the head and is mounted in a corresponding hole in the cover of the electrical device. The stop (63) is formed on and protrudes radially from the edge of the head, is sector shaped and selectively abuts the limit (52) on the sleeve (50) to limit the pivot angle of the shaft (60).

Because the external diameter of the torsion rod (61) is bigger than the internal diameter of the sleeve (50), the torsion rod (61) will become deformed when the torsion rod (61) is inserted into the sleeve (50). The torsion rod (61) is solid so the torsion rod (61) has no space to be deformed. Therefore, the torsion rod (61) will become non-circular (such as conical). However, a non-circular torsion rod (61) has non-uniform friction with the sleeve (50). The non-uniform friction causes the torsion rod (61) wear unevenly and the torsion rod (61) is damaged quickly. Furthermore, the torsion rod (61) rubs against the sleeve (50) in separate pieces because the slots (611) extend through the two ends of the torsion rod (61). The separate rubbing causes additional non-uniform friction.

To overcome the shortcomings, the present invention provides a hinge that provides uniform friction to mitigate or obviate the aforementioned problems.

### SUMMARY OF THE INVENTION

The main objective of the present invention is to provide a hinge that provides uniform friction. The hinge has a sleeve and a shaft and is mounted between a cover and a base of an electrical device. The sleeve is hollow, is attached to the base and has an internal diameter. The shaft is attached to the 24 cover, is mounted pivotally in the sleeve and has a hollow torsion rod. The torsion rod has an external diameter, an opening end and multiple slots. The external diameter of the torsion rod is bigger than the internal diameter of the sleeve to provide friction. The slots are formed in the torsion rod without communicating with the opening end to provide uniform friction. Because the torsion rod is hollow to provide spaces for the torsion rod to be deformed, the torsion rod maintains its shape. Therefore the torsion rod provides uniform friction with the sleeve.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is an exploded perspective view of the hinge in FIG. 1;

FIG. 3 is a perspective view of a notebook computer with two hinges in FIG. 1;

FIG. 4 is an end view of the hinge in FIG. 1;

FIG. 5 is an operational end view of the hinge in FIG. 1;

FIG. 6 is a perspective view of a conventional hinge in accordance with the prior art; and

FIG. 7 is an exploded perspective view of the conventional hinge in FIG. 6.

### DETAILED DESCRIPTION OF THE PREFERRED EMBODIMENTS

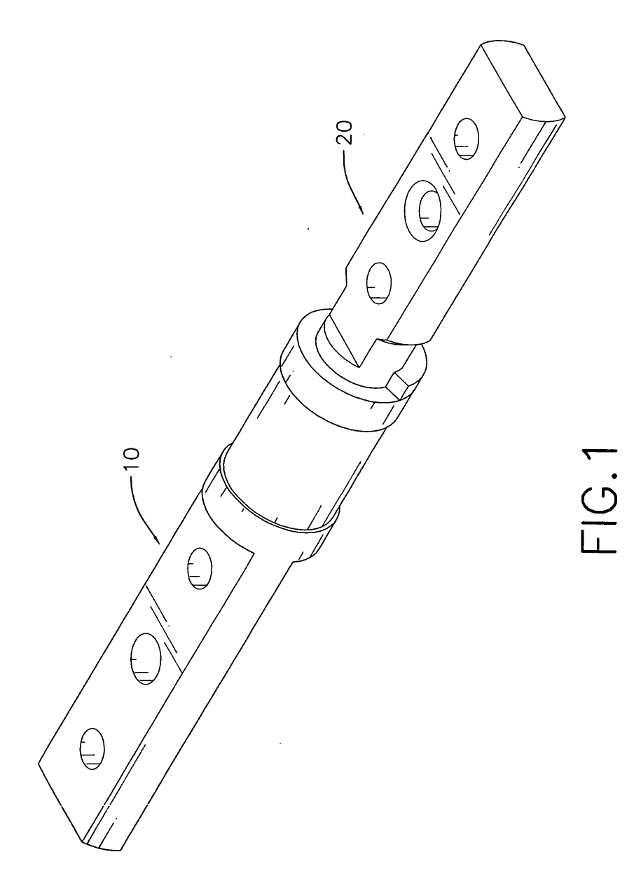

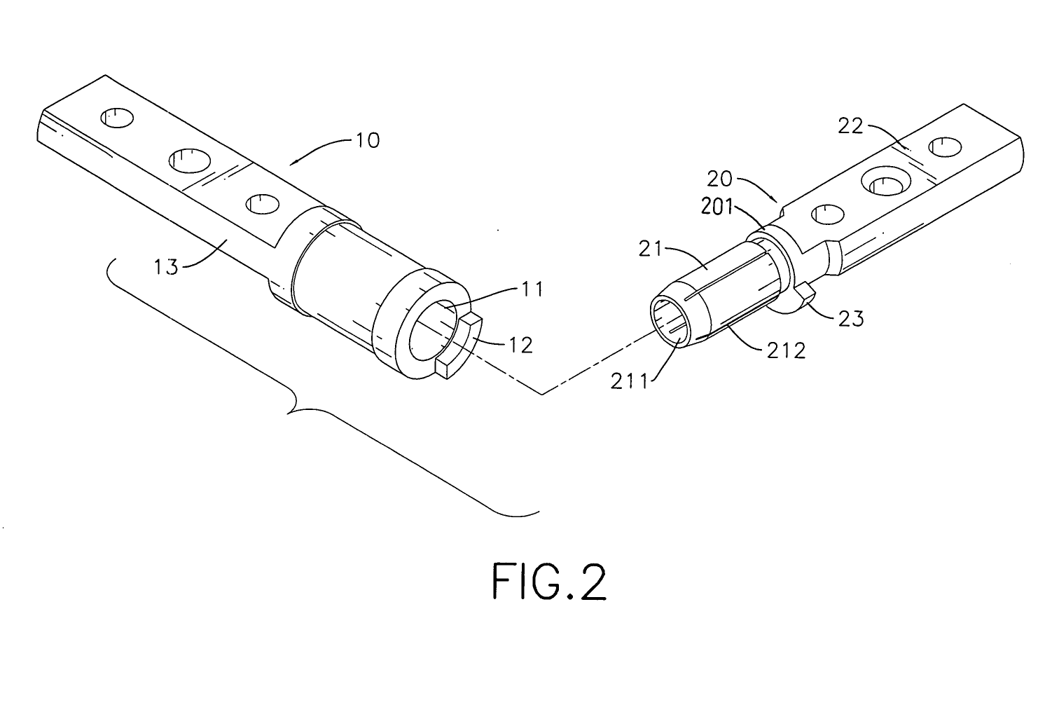

With reference to FIGS. 1 and 2, a hinge in accordance with the present invention comprises a sleeve (10) and shaft (20).

The sleeve (10) is hollow and has an internal diameter, an opening end (11), a close end, a limit (12) and a leaf (13). The limit (12) is formed axially on the opening end (11) and has two ends. The leaf (13) is formed on the close end.

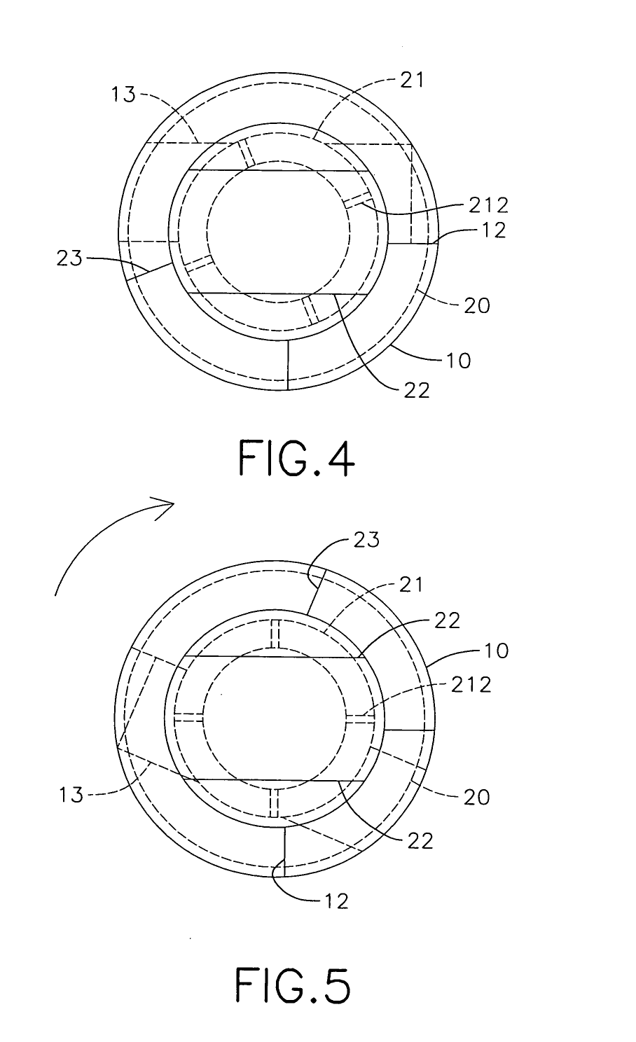

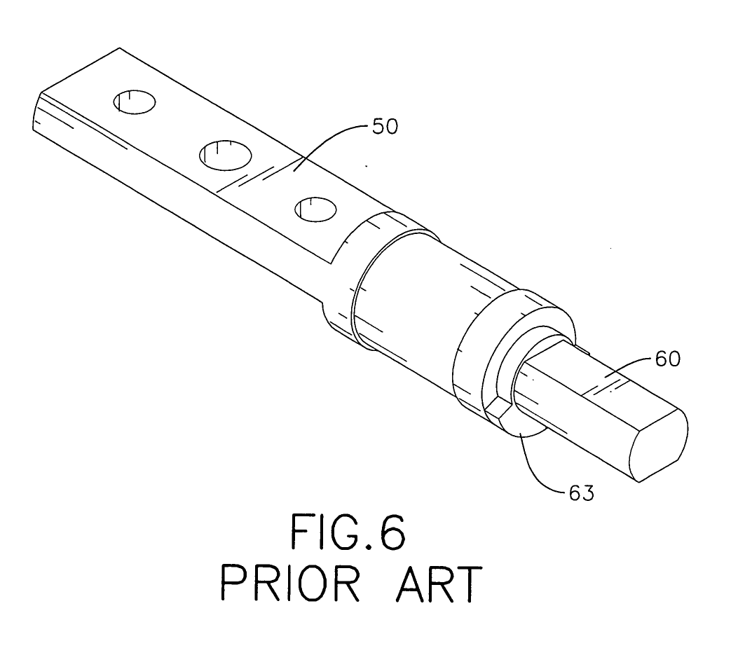

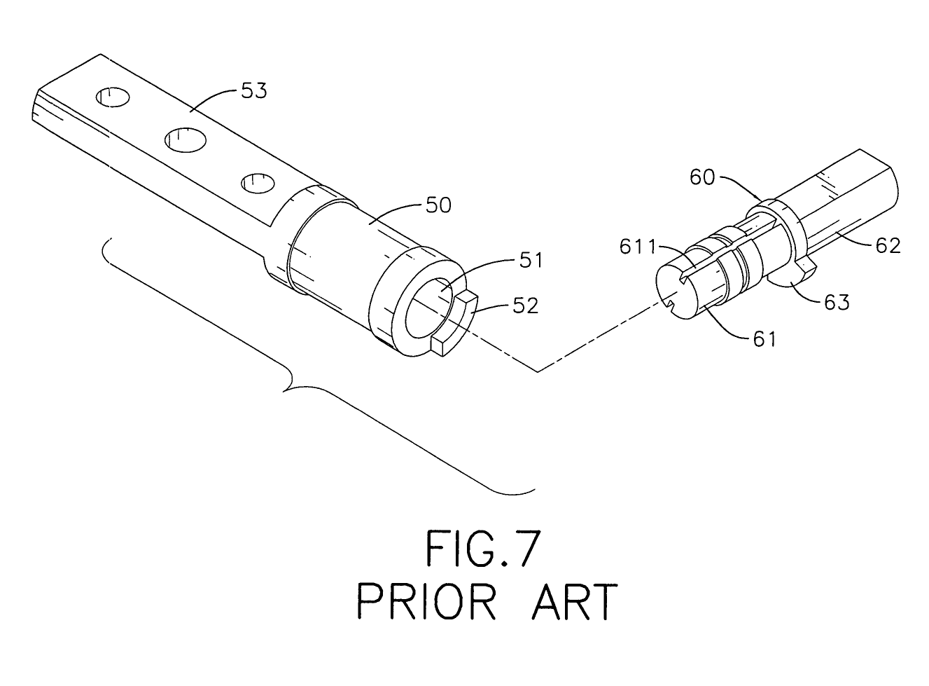

The shaft (20) is mounted rotatably in the sleeve (10) and has a head (201), a stop (23), a torsion rod (21) and a leaf (22). The head (201) abuts the opening end (11) of the sleeve (10) and has an edge, a proximal side and a distal side. With further reference to FIGS. 4 and 5, the stop (23) is formed radially on the edge of the head (201) and selectively abuts against the two ends of the limit (12) on the sleeve (10) to limit the rotating angle of the shaft (20). The torsion rod (21) is hollow, is formed axially on the proximal side of the head (201) and has an external diameter, an outer wall, an opening end (211), and multiple slots (212). The external diameter of the torsion rod (21) is bigger than the internal diameter of the sleeve (50). The opening end (211) of the torsion rod (21) may be narrower than the outer wall of the torsion rod (21) to let the torsion rod (21) to be easily inserted into the sleeve (10). The slots (212) are formed axially through the outer wall of the torsion rod (21) without communicating with the opening end (211) of the torsion rod (21). The leaf (22) is formed on the distal side of the head (201).

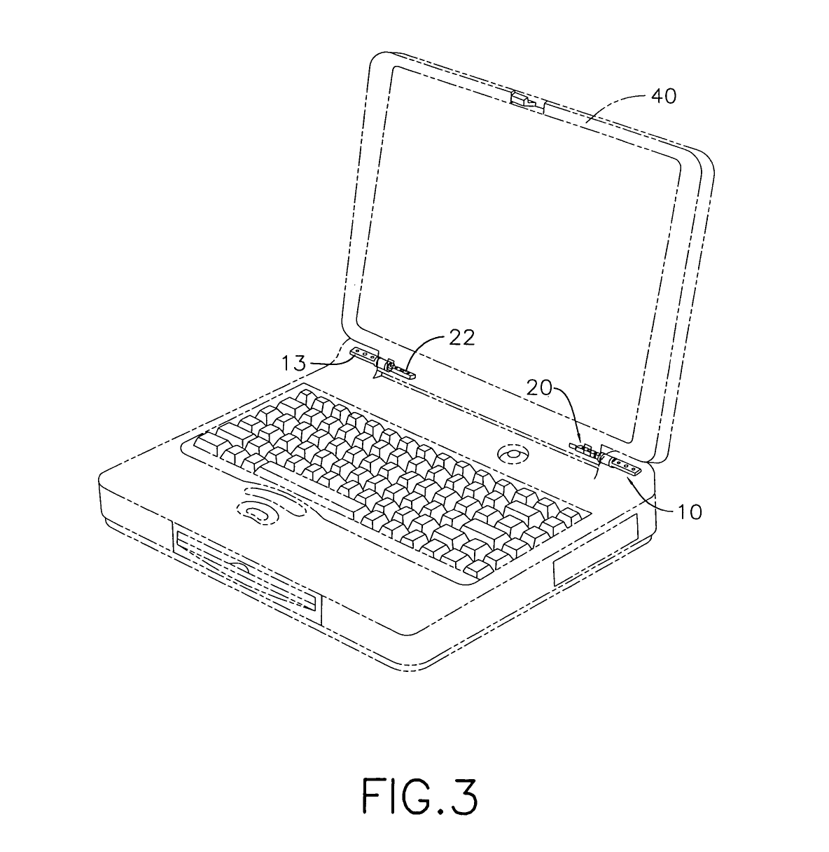

With further reference to FIG. 3, the hinge as described is mounted in an electrical appliance. The electrical appliance has a base (30) and a cover (40). The leaf (13) of the sleeve (10) is attached to the base (30). The leaf (22) of the shaft (20) is attached to the cover (40). When the cover (40) pivots relative to the base (30), the shaft (20) pivots relative to the sleeve (10). Because the external diameter of the torsion rod (21) is bigger than the internal diameter of the sleeve (10), the friction is provided between the sleeve (10) and the torsion rod (21) to position the cover (40) at any desired visual angle.

The hinge as described has numerous advantages. Because the torsion rod (21) is hollow, the torsion rod (21) has space to be deformed when the torsion rod (21) is inserted into the sleeve (10). Therefore, the torsion rod (21) will not become non-circular. Thus, the torsion rod (21) can provide uniform friction with the sleeve (10). Furthermore, the slots (212) of the torsion rod (21) are not formed through the opening end (211) of the torsion rod (21). Therefore, the torsion rod (21) rubs against the sleeve (10) with whole piece also to provide uniform friction. With uniform friction between the torsion rod (21) and the sleeve (10), the wear between the torsion rod (21) and the sleeve (10) is reduced and the lifespan of the hinge is extended.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a sleeve being hollow and having
an internal diameter;
an opening end;
a close end;
a limit formed axially on the opening end and having two ends; and
a leaf formed on the close end; and
a shaft mounted rotatably in the sleeve and having
a head abutting the opening end of the sleeve and having an edge, a proximal side and a distal side;
a stop formed radially on the edge of the head and selectively abutting against the two ends of the limit on the sleeve;
a torsion rod being hollow, formed axially on the proximal side of the head and having
an external diameter bigger than the internal diameter of the sleeve;
an outer wall;
an opening end; and
multiple slots formed axially through the outer wall of the torsion rod without communicating with the opening end of the torsion rod; and
a leaf formed on the distal side of the head.

2. The hinge as claimed in claim 1, wherein the opening end of the torsion rod is narrower than the outer wall of the torsion rod.
